(19) United States
(12) Patent Application Publication
(10) Pub. No.: US 2026/0155413 A1
(43) Pub. Date: Jun. 4, 2026

(54) METHOD OF CONTROLLING OPENING DEGREE OF AIR FLOW RATE CONTROL VALVE IN FUEL CELL STACK AND APPARATUS

(71) Applicants: Hyundai Motor Company, Seoul (KR); Kia Corporation, Seoul (KR)

(72) Inventors: Seung Man Park, Hwaseong-Si (KR); Jae Sung Ryu, Hwaseong-Si (KR); Ji Hoon Ryu, Hwaseong-Si (KR)

(21) Appl. No.: 19/228,052

(22) Filed: Jun. 4, 2025

(30) Foreign Application Priority Data
Nov. 29, 2024 (KR) 10-2024-0175655

(51) Int. Cl. H01M 8/04992; B60L 58/30; H01M 8/04302; H01M 8/04537; H01M 8/04664; H01M 8/04746; H01M 8/04858; H01M 8/10

(52) U.S. Cl. CPC H01M 8/04992; B60L 58/30; H01M 8/04302; H01M 8/04559; H01M 8/04567; H01M 8/04589; H01M 8/04679; H01M 8/04753; H01M 8/04888; H01M 2008/1095; H01M 2250/20

(57) ABSTRACT

An apparatus of a fuel cell system may perform a method comprising, based on entry into an idle operation state of a fuel cell stack of the fuel cell system after start-up of the fuel cell system, controlling airflow to the fuel cell stack such that a current of the fuel cell stack converges to a predetermined current, based on the current of the fuel cell stack converging to the predetermined current, controlling a voltage drop slope of a fuel-cell direct current DC-DC converter (FDC), and controlling, based on the controlled voltage drop slope of the FDC, an operation of the fuel cell stack.

### CROSS-REFERENCE TO RELATED APPLICATION

This application claims the benefit of priority to Korean Patent Application No. 10-2024-0175655, filed in the Korean Intellectual Property Office on Nov. 29, 2024, the entire contents of which are incorporated herein by reference.

### TECHNICAL FIELD

The present disclosure relates to a fuel cell system, and more particularly, to a technology for controlling an opening degree of an air flow rate control valve according to stack degradation in a fuel cell system entering an idle operation state.

### BACKGROUND

The matters described in this Background section are only for enhancement of understanding of the background of the disclosure, and should not be taken as acknowledgment that they correspond to prior art already known to those skilled in the art.

Carbon neutrality is a hot topic around the world. Major economies are seeking ways for expanding electricity production using renewable energy instead of fossil energy.

A green energy system is a system that uses, as electrical and hydrogen energy, energy obtained through the renewable energy such as wind power, hydro power, tidal power, and solar power.

Among them, green hydrogen is evaluated as ultimate eco-friendly energy because the green hydrogen does emit no greenhouse gas from a production stage, and hydrogen, which is emerging as alternative energy at the global level, is roughly classified into gray hydrogen, blue hydrogen, and green hydrogen depending on a production method.

Research on electric vehicles equipped with eco-friendly hydrogen fuel cells are actively conducted.

Hydrogen fuel-based electric vehicles may provide a fast charging time and a long driving distance with a single hydrogen charge due to high energy density thereof as compared to general electric vehicles based on high voltage batteries.

In a vehicle fuel cell system, hydrogen that is a fuel and air that is an oxidant agent are continuously supplied to a stack in a normal operation state, and a current generated through an electrochemical reaction in the stack is withdrawn to charge a battery or supply power to an inverter so as to drive a vehicle motor. The hydrogen and the air supplied to the stack continuously circulate between an anode that is a fuel electrode and a cathode that is an air electrode.

On the other hand, in an idle operation state, a current is not withdrawn, and the hydrogen and the air are supplied only for the purpose of maintaining a differential pressure. Thus, the hydrogen and the air are difficult to circulate between the anode and the cathode. This may increase the amount of a gas crossover between the anode and the cathode and may easily generate side reactions.

When a cell voltage of the stack is 0.8V or more in the idle operation state, an oxide film may be formed to reduce an electrochemical surface area, which may cause stack degradation.

Further, in the idle operation state, oxygen transferred from the cathode to the anode may cause the following side reactions on an electrode surface to produce hydrogen peroxide (OH⁻), and the hydrogen peroxide may generate oxygen radicals to cause decomposition of a polymer electrolyte membrane, and thus may degrade physical properties. To reduce the amount of the gas crossover, the air supplied to the cathode may be cut off by turning off an air compressor or bypassing the air through an air flow rate control valve. However, such approach may reduce durability of a single product, and more than 20 seconds may be taken until a voltage naturally exhausted.

Thus, a new method is being considered to avoid high potential exposure and efficiently reduce the amount of the gas crossover in the idle operation state.

### SUMMARY

The present disclosure has been made to solve the above-mentioned problems.

According to the present disclosure, a method performed by an apparatus of a fuel cell system, the method may comprise, based on entry into an idle operation state of a fuel cell stack of the fuel cell system after start-up of the fuel cell system, controlling airflow to the fuel cell stack such that a current of the fuel cell stack converges to a predetermined current, based on the current of the fuel cell stack converging to the predetermined current, controlling a voltage drop slope of a fuel-cell direct current DC-DC converter (FDC), and controlling, based on the controlled voltage drop slope of the FDC, an operation of the fuel cell stack.

The method may further comprise, performing, based on a voltage of the fuel cell stack, a feedback-based control for an air flow rate control valve of the fuel cell system, and increasing, based on a degradation degree value of the fuel cell stack, a valve opening degree value of the air flow rate control valve, wherein the degradation degree value of the fuel cell stack is determined based on a count of instances of performing the feedback-based control during the idle operation state of the fuel cell stack.

The method, wherein the air flow rate control valve may comprise, an air cut-off valve (ACV) that is a valve configured to block air supplied to the fuel cell stack, and an air pressure control valve (APC) that is a valve configured to control an air pressure.

The method, wherein the performing of the feedback-based control may comprise, obtaining a current output voltage value of the fuel cell stack, obtaining a target output voltage value of the fuel cell stack associated with the current output voltage value, and identifying a voltage deviation between the target output voltage value and the current output voltage value, and wherein the feedback-based control is performed based on the voltage deviation being greater than a predetermined reference deviation.

The method, wherein the target output voltage value is determined based on the voltage drop slope of the FDC, and wherein the voltage drop slope of the FDC is applied during the idle operation state of the fuel cell stack.

The method, wherein the voltage drop slope of the FDC is determined based on, an output voltage value of the fuel cell stack after entering the idle operation state, the target output voltage value, and a predetermined waiting time for reaching the target output voltage value.

The method, wherein the performing of the feedback-based control further may comprise, based on the voltage deviation being greater than the predetermined reference deviation, determining a valve opening degree upward value required for the current output voltage value of the fuel cell stack to follow the voltage drop slope of the FDC, and controlling, based on the determined valve opening degree upward value, the air flow rate control valve.

The method, wherein the increasing of the valve opening degree value may comprise, counting a number of instances of entering into the idle operation state of the fuel cell stack after the start-up of the fuel cell system, counting a number of instances of performing the feedback-based control during the idle operation state of the fuel cell stack, calculating a ratio of the number of instances of performing the feedback-based control to the number of instances of entering into the idle operation state, and determining, based on the ratio, a valve opening degree upward value, and wherein the ratio is calculated based on the number of instances of entering into the idle operation state after the start-up being greater than a predetermined reference value.

The method may further comprise, based on the voltage deviation being less than or equal to the predetermined reference deviation, determining that an output voltage value of the fuel cell stack is within a voltage value range defined by the voltage drop slope of the FDC, and controlling the air flow rate control valve to maintain a current opening degree.

The method may further comprise, initializing, upon re-start of the fuel cell system, the valve opening degree value of the air flow rate control valve.

According to the present disclosure, an apparatus of a fuel cell system, the apparatus may comprise, a processor, and a memory storing at least one instruction that, when executed by the processor communicating with the memory, is configured to cause the apparatus to, based on entry into an idle operation state of a fuel cell stack of the fuel cell system after start-up of the fuel cell system, control airflow to the fuel cell stack such that a current of a fuel cell stack converges to a predetermined current, and based on the current of the fuel cell stack converging to the predetermined current, control a voltage drop slope of a fuel-cell direct current DC-DC converter (FDC).

The apparatus, wherein the at least one instruction, when executed by the processor communicating with the memory, is configured to cause the apparatus to, perform, based on a voltage of the fuel cell stack, a feedback-based control for an air flow rate control valve of the fuel cell system, and increase, based on a degradation degree value of the fuel cell stack, a valve opening degree value of the air flow rate control valve, and wherein the degradation degree value of the fuel cell stack is determined based on a count of instances of performing the feedback-based control during the idle operation state of the fuel cell stack.

The apparatus, wherein the air flow rate control valve may comprise, an air cut-off valve (ACV) that is a valve configured to block air supplied to the fuel cell stack, and an air pressure control valve (APC) that is a valve configured to control an air pressure.

The apparatus, wherein the at least one instruction, when executed by the processor communicating with the memory, is configured to cause the apparatus to perform the feedback-based control by, obtaining a current output voltage value of the fuel cell stack, identifying a target output voltage value of the fuel cell stack associated with the current output voltage value, and identifying a voltage deviation between the target output voltage value and the current output voltage value, and wherein the feedback-based control is performed based on the voltage deviation being greater than a predetermined reference deviation.

The apparatus, wherein the target output voltage value is determined based on the voltage drop slope of the FDC, and wherein the voltage drop slope of the FDC is applied during the idle operation state of the fuel cell stack.

The apparatus, wherein the voltage drop slope of the FDC is determined based on, an output voltage value of the fuel cell stack after entering the idle operation state, the target output voltage value, and a predetermined waiting time for reaching the target output voltage value.

According to the present disclosure, a method performed by an apparatus of a fuel cell system, the method may comprise, reducing, based on detecting entry into an idle operation state of a fuel cell stack of the fuel cell system, an air supply to the fuel cell stack to decrease a current of the fuel cell stack, controlling, based on the current of the fuel cell stack being reduced to a predetermined threshold, a voltage of the fuel cell stack to follow a predefined voltage drop profile during the idle operation state, adjusting an air supply condition based on a deviation between the voltage of the fuel cell stack and a reference voltage, and controlling, based on the adjusted air supply condition, an operation of the fuel cell system.

The method, wherein the adjusting of the air supply condition may comprise adjusting, based on the deviation, an opening degree of an air flow control valve of the fuel cell system.

The method may further comprise, based on a frequency of adjustments during a plurality of idle operation states of the fuel cell stack, updating a control parameter for the air supply condition.

The method, wherein the predefined voltage drop profile is defined based on a difference between an initial voltage of the fuel cell stack and a target output voltage value and based on a time duration for reaching the target output voltage value.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a fuel cell system according to an embodiment of the present disclosure;

FIG. 2 shows an example of an overall configuration of a vehicle fuel cell system according to the embodiment of the present disclosure;

FIG. 3 shows an example of a fuel cell system and an operation of controlling an opening degree of an air flow rate control valve based on a fuel-cell direct current DC-DC converter (FDC) voltage drop slope thereof according to the embodiment of the present disclosure;

FIG. 4 shows an example of an electrochemical reaction in a fuel cell stack according to the present disclosure;

FIG. 5 shows an example of a detailed configuration of a fuel cell controller (FCC) of FIG. 3;

FIG. 6 shows an example of a method of controlling the opening degree of the air flow rate control valve in the fuel cell stack according to the embodiment of the present disclosure;

FIG. 7 shows an example of a method of controlling the opening degree of the air flow rate control valve based on the FDC voltage drop slope in the fuel cell system according to the embodiment of the present disclosure;

FIG. 8 shows an example of a method of controlling an opening degree of an air flow rate control valve based on an FDC voltage drop slope in a fuel cell system according to another embodiment of the present disclosure;

FIG. 9 shows an example of an example of controlling the opening degree of the air flow rate control valve based on the FDC voltage drop slope in the fuel cell system according to the embodiment of the present disclosure; and

FIG. 10 shows an example of a computing device according to the embodiment of the present disclosure.

### DETAILED DESCRIPTION

Hereinafter, some embodiments of the present disclosure will be described in detail with reference to the exemplary drawings. In adding reference numerals to components of each drawing, it should be noted that identical or equivalent components are designated by an identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish one component from other components, and the terms do not limit the nature, order, or sequence of the components. Unless otherwise defined, all terms including technical and scientific terms used herein include the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

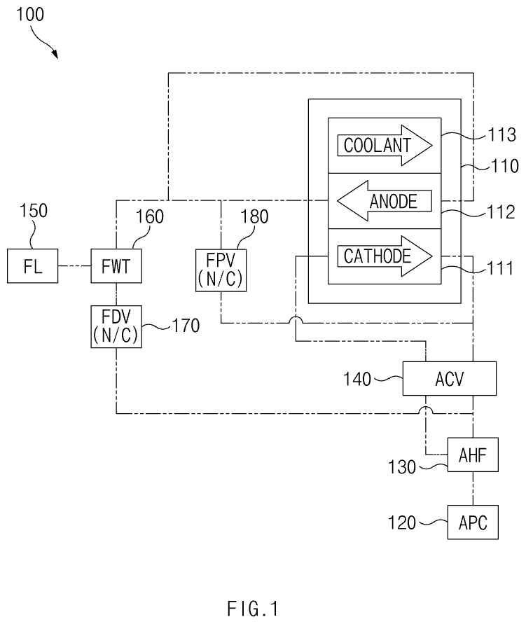

Hereinafter, embodiments of the present disclosure will be described in detail with reference to FIGS. 1 to 10.

FIG. 1 shows an example of a fuel cell system according to an embodiment of the present disclosure.

As illustrated in FIG. 1, in a fuel cell system 100 according to an embodiment of the present disclosure, oxygen (air) and hydrogen, which are fuels of a fuel cell stack 110, are supplied to a cathode 111 and an anode 112 of a membrane electrode assembly through a flow path of a separation plate, respectively (e.g., serpentine channels, parallel flow fields, or interdigitated paths, etc.). For example, the oxygen (air) is supplied to the cathode 111 in the fuel cell stack 110, and the hydrogen is supplied to the anode 112 in the fuel cell stack 110 (e.g., via flow channels, distribution manifolds, or inlet ports, etc.).

Further, a coolant 113 stored in a refrigerant storage (not illustrated) may be supplied into the fuel cell stack 110 through a cooling line (e.g., a closed-loop coolant circuit, a thermal management line, or a heat exchange conduit, etc.).

First, an air humidifier (hereinafter, referred to as an “AHF”) 130 for maintaining humidity of the oxygen (air) that is important in a reaction of the fuel cell stack 110 and valves for controlling supply of the oxygen (air), (e.g., an air cut-off valve (hereinafter, referred to as an “ACV) 140 and an air pressure control valve (or an operating pressure control valve)(hereinafter, referred to as a “APC”) 120, etc.) may be configured on the cathode 111.

Here, the AHF 130 supplies moisture from an oxygen (air) inlet side, and the oxygen (air) supplied with the moisture moves along a flow path in the fuel cell stack 110, reacts with the hydrogen (e.g., to generate electricity, water, and heat, etc.), and then generates water. Here, the water generated by the electrochemical reaction interferes with flow of the oxygen and the hydrogen and thus needs to be removed from the fuel cell stack 110 (e.g., through drainage systems, purge operations, or water traps, etc.).

Thus, at least one of a fuel-line purge valve (hereinafter, referred to as “FPV”) 180, a fuel-line water trap (hereinafter, referred to as “FWT”) 160, a fuel-line level sensor (hereinafter, referred to as “FL”) 150, and a fuel-line drain valve (hereinafter, referred to as “FDV”) 170 for discharging impurities and condensate (e.g., water, nitrogen, or residual hydrogen, etc.) in the fuel cell stack 110 may be configured on the anode 112. In detail, the FPV 180 discharges impurities (e.g., nitrogen, inert gases, or contaminants, etc.) generated by the anode 112 in the fuel cell stack 110, and the FWT 160 collects the condensate generated by the anode 112 in the fuel cell stack 110 to a certain level and then discharges the collected condensate toward the cathode 111 through the FDV 170 (e.g., using a pressure-driven flow, a purge burst, or a timed drain sequence, etc.).

In order to improve efficiency of the fuel cell stack 110, the APC 120 functions to control an angle of a valve disk during operation to adjust a pressure of a flow path of an air supply system (or an oxidant gas supply system, such as a cathode air path, air loop, or oxidant manifold, etc.).

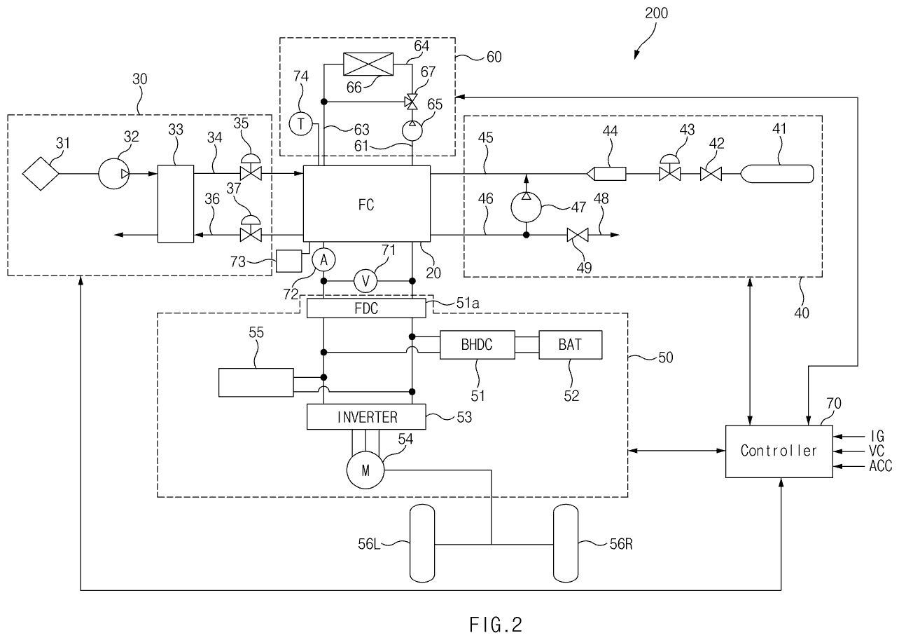

FIG. 2 shows an example of an overall configuration of a vehicle fuel cell system according to the embodiment of the present disclosure.

A vehicle fuel cell system 200 may function as a vehicle-mounted power system mounted on a fuel cell vehicle and may include a fuel cell stack 20 that generates power by receiving a reaction gas (e.g., a fuel gas, an oxidant gas, ambient air, or reformed fuel gas, etc.), an oxidant gas supply system 30 for supplying air as the oxidant gas to the fuel cell stack 20, a fuel gas supply system 40 for supplying hydrogen gas as the fuel gas to the fuel cell stack 20, a power meter 50 for controlling charging or discharging of the power, a cooling system 60 for cooling the fuel cell stack 20, and a controller (ECU) 70 that controls the entire system (e.g., operating modes, valve actuations, or system diagnostics, etc.).

The fuel cell stack 20 may be a solid polymer electrolyte type cell stack formed by laminating a plurality of cells in series (e.g., MEAs stacked with bipolar plates, end plates, and tie rods, etc.). An oxidation reaction occurs at the anode 112 of the fuel cell stack 20, and a reduction reaction occurs at the cathode 111.

A voltage sensor 71 for detecting an output voltage of the fuel cell stack 20, a current sensor 72 for detecting a generated current, and a cell voltage sensor 73 for detecting a cell voltage may be installed in the fuel cell stack 20 (e.g., integrated into the stack frame, positioned at key monitoring channels, or embedded in stack interconnects, etc.).

The oxidant gas supply system 30 may include an oxidant gas passage 34 through which the oxidant gas supplied to the cathode 111 of the fuel cell stack 20 flows and an oxidation-off gas passage 36 through which an oxidant-off gas discharged from the fuel cell stack 20 flows (e.g., residual air, moisture, or inert byproducts, etc.). An air compressor 32 that introduces the oxidant gas from the atmosphere through a filter 31 and compresses the oxidant gas, a humidifier 33 for humidifying the oxidant gas supplied to the cathode 111 of the fuel cell stack 20, and a throttle valve 35 for adjusting the amount of the supplied oxidant gas may be installed in the oxidant gas passage 34 (e.g., to manage stoichiometric flow rates or oxygen excess ratios, etc.). A rear pressure adjustment valve 37 for adjusting an oxidation gas supply pressure and the humidifier 33 for exchanging moisture between the oxidant gas (dry gas) and an oxidation-off gas (wet gas) may be installed in the oxidation-off gas passage 36 (e.g., for humidity recovery, thermal regulation, or pressure balancing, etc.).

The fuel gas supply system 40 may include a fuel gas supply source 41, a fuel gas passage 45 through which the fuel gas supplied from the fuel gas supply source 41 to the anode 112 of the fuel cell stack 20 flows, a circulation passage 46 for returning a fuel-off gas discharged from the fuel cell stack 20 to the fuel gas passage 45, a circulation pump 47 for pumping the fuel-off gas inside the circulation passage 46 to the fuel gas passage 45, and an exhaust drain passage 48 branched and connected to the circulation passage 46 (e.g., to remove accumulated water, nitrogen, or contaminants, etc.).

For example, the fuel gas supply source 41 may be formed as a high-pressure hydrogen tank or formed of a hydrogen absorbing alloy and may store the hydrogen gas having a high pressure (e.g., 35 MPa to 70 MPa, or higher depending on the vehicle platform, etc.). When a shut-off valve 42 is opened, the fuel gas flows out from the fuel gas supply source 41 into the fuel gas passage 45 (e.g., under tank pressure via a high-pressure line or regulated flow channel, etc.). The fuel gas may be depressurized by a regulator 43 or an ejector 44 to, for example, about 200 kPa and supplied to the fuel cell stack 20.

Further, the fuel gas supply source 41 may include a reformer that produces a hydrogen-rich reformed gas from a hydrocarbon-based fuel (e.g., natural gas, methanol, or gasoline, etc.) and a high-pressure gas tank that compresses the reformed gas produced in this reformer to a high-pressure state.

The regulator 43 may be a device that regulates an upstream pressure (primary pressure) to a preset secondary pressure (e.g., suitable for stack inlet conditions such as 110 kPa to 250 kPa, etc.) and may include, for example, a mechanical pressure reducing valve that reduces the primary pressure. The mechanical pressure reducing valve may have a housing in which a back pressure chamber and a pressure control chamber are separated from a diaphragm (e.g., made of elastomer, fluoropolymer, or reinforced membrane material, etc.), and may reduce the primary pressure to a predetermined pressure in the pressure control chamber by a back pressure inside the back pressure chamber, and thus may have the secondary pressure (e.g., suitable for fuel cell stack input, such as 110-250 kPa, etc.).

The ejector 44 may be an electronically driven opening or closing valve capable of adjusting a flow rate or a pressure of the gas by driving a valve body directly at a predetermined driving cycle with an electronically driven force (e.g., via a solenoid, motor actuator, or piezoelectric element, etc.) and separating the valve body from a valve seat. The ejector 44 may include the valve seat having an injection hole through which a gas fuel such as the fuel gas is injected (e.g., hydrogen, reformate gas, or synthetic gas, etc.) and may include a nozzle body that supplies and guides the gas fuel to the injection hole (e.g., through a tapered channel, swirl passage, or multi-port inlet, etc.) and a valve body that is accommodated and maintained to be movable in an axial direction (gas flow direction) with respect to the nozzle body and opens or closes the injection hole (e.g., via solenoid actuation, stepper motor control, or piezoelectric drive, etc.).

An exhaust drain valve 49 may be disposed in the exhaust drain passage 48 (e.g., near a low-point trap, junction manifold, or condensate collection zone, etc.). The exhaust drain valve 49 may be operated by a command from the controller 70 to discharge the fuel off gas and the moisture including impurities in the circulation passage 46 to the outside (e.g., during purge cycles, shutdown procedures, or condensate management events, etc.). By opening (e.g., using an opening valve of the exhaust drain valve 49) the exhaust drain value 49, a concentration of impurities in the fuel-off gas in the circulation passage 46 may be lowered, and a concentration of the hydrogen in the fuel-off gas circulating in the circulation system may be increased e.g., thereby improving fuel utilization, stack efficiency, and reaction uniformity, etc.).

The fuel-off gas discharged through the exhaust drain valve 49 is mixed with the oxidation-off gas flowing through the oxidation-off gas passage 36 and diluted by a dilutor (not illustrated) (e.g., to meet exhaust safety standards, reduce flammability, or stabilize exhaust composition, etc.). The circulation pump 47 may circulate and supply the fuel-off gas in the circulation system to the fuel cell stack 20 by driving a motor (e.g., an electric motor with speed control based on flow demand, stack load, or purge timing, etc.).

The power meter 50 may include a fuel-cell direct current DC-DC converter (hereinafter, referred to as an “FDC”) 51a, a bidirectional high voltage DC-DC Converter (hereinafter, referred to as a “BHDC”) 51b, a high voltage battery 52, a traction inverter 53, a traction motor 54, and an auxiliary device 55. The FDC 51a may be a bidirectional voltage converter that is responsible for controlling the output voltage of the fuel cell stack 20, and may convert (increases or decreases) the output voltage input to a primary side (e.g., an input side: the fuel cell stack 20) into a voltage different from that of the primary side to output the converted voltage to the secondary side (e.g., an output side: the inverter 53), and conversely, converts a voltage input to the secondary side into a voltage different from that of the secondary side to output the converted voltage to the primary side (e.g., to support load transients, regenerative braking, or battery buffering, etc.). Operating points I and V of the fuel cell stack 20 may be controlled by the voltage conversion control by the FDC 51a (e.g., for maintaining power quality, stack efficiency, or battery integration, etc.).

The BHDC 51b may serve to control an input voltage of the inverter 53 and may have, for example, an identical or similar circuit configuration to that of the FDC 51a, but the present disclosure is not limited thereto, and the circuit configuration of the BHDC 51b may employ all configurations capable of controlling the input voltage of the inverter 53 (e.g., via buck, boost, or full-bridge topologies, etc.). The BHDC 51b may convert the power generated by the fuel cell stack 20 to charge the high voltage battery 52 or convert the power charged in the high voltage battery 52 to supply the converted power to the traction inverter 53 and the auxiliary device 55 (e.g., HVAC systems, pumps, sensors, or ECUs, etc.).

The high voltage battery 52 may function as a storage source of surplus power, a regenerative energy storage source during regenerative braking, and an energy buffer when a load changes according to acceleration or deceleration of the fuel cell vehicle (e.g., during rapid throttle input, gear shifts, or downhill coasting, etc.). For example, a secondary battery such as a nickel-cadmium storage battery, a nickel-hydrogen storage battery, and a lithium secondary battery (e.g., lithium-ion, lithium-polymer, or lithium iron phosphate, etc.) may be suitable as the high voltage battery 52.

The traction inverter 53 may be, for example, a pulse width modulation (PWM) inverter driven by a pulse width modulation manner and may control a rotational torque of the traction motor 54 by converting a DC voltage output from the fuel cell stack 20 or the high voltage battery 52 into a three-phase alternating current (AC) voltage according to a control command from the controller 70. The traction motor 54 is a motor (e.g., a three-phase AC motor, a permanent magnet synchronous motor, or a switched reluctance motor, etc.) for driving wheels 56L and 56R and may constitute a power source of the fuel cell vehicle (e.g., providing propulsion torque under various load and terrain conditions, etc.).

The auxiliary device 55 collectively refers to motors (e.g., a power source such as a pump, fan motor, or blower motor, etc.) disposed in parts of the fuel cell system 100, inverters for driving these motors, and various vehicle-mounted auxiliary devices (e.g., an air compressor, an injector, a coolant circulation pump, a radiator, a cabin HVAC blower, or an exhaust system component, etc.).

The cooling system 60 may include refrigerant passages 61, 62, 63, and 64 for allowing a refrigerant circulating inside the fuel cell stack 20 to flow therethrough, a circulation pump 65 for pumping the refrigerant, a radiator 66 for heat exchange between the refrigerant and outside air, a three-way valve 67 for switching a circulation path of the refrigerant, and a temperature sensor 74 for detecting a temperature of the fuel cell stack 20 (e.g., to maintain thermal balance, prevent overheating, or optimize electrochemical efficiency, etc.). In a normal operation after warm air operation is completed, the three-way valve 67 may be controlled to be opened or closed such that the refrigerant flowing from the fuel cell stack 20 flows through the refrigerant passages 61 and 64, is cooled by the radiator 66, and then flows back into the fuel cell stack 20 (e.g., to maintain optimal stack operating temperature, such as 60-80° C., etc.). During the warm air operation immediately after the system is started up, the three-way valve 67 may be controlled to be opened or closed such that the refrigerant flowing out from the fuel cell stack 20 flows through the refrigerant passages 61, 62, and 63 and flows back into the fuel cell stack 20 (e.g., bypassing the radiator to accelerate warm-up, etc.).

The controller 70 is a computer system equipped with a central processing unit (CPU), a read only memory (ROM), a random access memory (RAM), and an input/output interface and functions as a control means for controlling each part (e.g., the oxidant gas supply system 30, the fuel gas supply system 40, the power meter 50, and the cooling system 60, etc.) of the fuel cell system 100. For example, when the controller 70 receives a start-up signal IG output from an ignition switch, the controller 70 may start to operate the fuel cell system 100 and calculate the power required for the entire system based on an accelerator opening degree signal ACC output from an accelerator sensor, a vehicle speed signal VC output from a vehicle speed sensor, or the like (e.g., throttle demand, regenerative braking mode, or vehicle climb angle, etc.).

The power required for the entire system is a sum of power required for driving the vehicle and auxiliary power. The auxiliary power may include power consumed by the vehicle-mounted auxiliary devices (e.g., a humidifier, an air compressor, a hydrogen pump, or a coolant circulation pump, etc.), power consumed by devices (e.g., a transmission, a wheel control device, a steering device or a suspension device, etc.) required for driving the vehicle, and power consumed by devices (e.g., an air conditioner, a lighting fixture, or an audio system, etc.) arranged in an occupant space (e.g., to support passenger comfort and infotainment, etc.).

Additionally, the controller 70 may control the oxidant gas supply system 30 and the fuel gas supply system 40 so that distribution of output power of the fuel cell stack 20 and the high voltage battery 52 is determined, a generation command value is calculated, and the amount of power generation of the fuel cell stack 20 satisfies a required power generation amount P_{req} (e.g., based on driver demand, battery SOC, or energy efficiency optimization, etc.). Further, the controller 70 may control an operating point of the fuel cell stack 20 by controlling the FDC 51a or the like. To obtain a target vehicle speed according to an accelerator opening degree, the controller 70 may output, for example, AC voltage command values of a U phase, a V phase, and W phase as switching commands to the traction inverter 53 and control an output torque and the number of rotations of the traction motor 54 (e.g., in response to slope, road load, or regenerative braking, etc.).

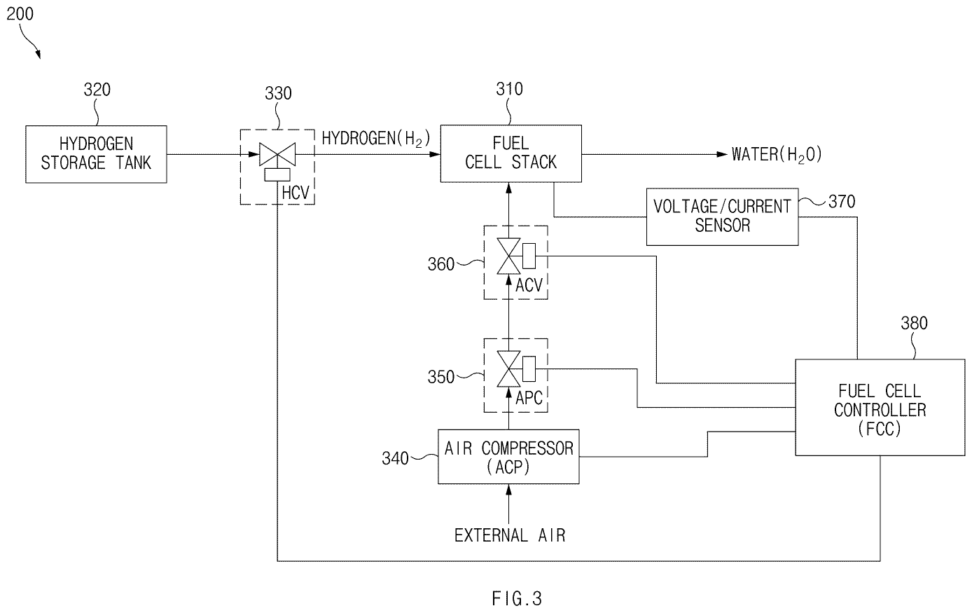

FIG. 3 shows an example of a fuel cell system and an operation of controlling an opening degree of an air flow rate control valve based on a fuel-cell direct current DC-DC converter (FDC) voltage drop slope thereof according to the embodiment of the present disclosure.

Referring to FIG. 3, a fuel cell system 300 may include at least one of a fuel cell stack 310, a hydrogen storage tank 320, a hydrogen control valve (HCV) 330, an air compressor (ACP) 340, an air pressure control valve (APC) 350, an air shut-off valve (ACV) 360, a voltage/current sensor 370, and a fuel cell controller (FCC) 380 (e.g., implemented as an embedded control circuit or integrated system-level controller, etc.).

The fuel cell stack 310 may generate power by performing an electrochemical reaction using, as fuel, hydrogen (H₂) introduced from the hydrogen storage tank 320 and air introduced from outside a vehicle, wherein the air includes oxygen (O₂). Here, the generated power may be provided to an inverter that converts power to charge a battery (not illustrated) of the vehicle or drive a motor (not illustrated) provided in the vehicle, through the FDC (not illustrated) (e.g., depending on load demands or energy management strategies, etc.).

The amount of the hydrogen as fuel introduced into the fuel cell stack 310 may be controlled through the HCV 330, and the amount of the air as an oxidant agent may be controlled by controlling at least one of the ACP 340, the APC 350, and the ACV 360 (e.g., based on pressure sensors, flow rate targets, or stack temperature, etc.).

The FCC 380 may control at least one of the HCV 330, the ACP 340, the APC 350, and the ACV 360 to control the amount of hydrogen and the amount of oxygen supplied to the fuel cell stack 310 (e.g., to maintain an optimal stoichiometric ratio, manage thermal load, or reduce parasitic loss, etc.).

The voltage/current sensor 370 may include a voltage sensor for detecting an output voltage of the fuel cell stack 310 and a current sensor for detecting a generation current (e.g., using shunt resistors, Hall-effect sensors, or stack-integrated sensing circuitry, etc.). Here, the output voltage may be detected in units of channels of the fuel cell stack 310 and/or in units of cells in the channels, and the generation current may be detected in the units of the channels and/or in units of the cells in the channels and/or in units of segments in the cells (e.g., for localized performance diagnostics, degradation tracking, or balancing purposes, etc.). The voltage/current sensor 370 may provide the current and voltage detection results to the FCC 380. Here, one channel may include a plurality of cells, and one cell may include of a plurality of segments.

When entering an idle operation state after start-up, the FCC 380 may obtain information on voltage and/or current distribution inside the current fuel cell stack 110 by requesting the voltage/current sensor 370 to measure a voltage and/or a current through a predetermined control command (e.g., issued at stack cooldown, vehicle stop, or neutral load states, etc.).

The FCC 380 according to the embodiment may perform a control such that, while the ACP 340 is maintained at a minimum or target revolution per minute (RPM) for a predetermined period of time at an initial time point of entering the idle operation state, valve disks of the ACV 360 and the APC 350 are almost closed, and thus only a minimum or target flow rate of the air is supplied to the cathode 111 (e.g., to reduce parasitic load, suppress hydrogen crossover, or stabilize stack voltage, etc.). In this case, the current of the fuel cell stack 310 may converge to a preset target (e.g., minimum) current or less through the supply of the air at the minimum flow rate. Here, the target (e.g., minimum) current is for the purpose of controlling 0 A, but may be set to a constant value close to 0 A in consideration of an offset or the like of a sensor (e.g., to account for sensor drift or hardware threshold, etc.). For example, the minimum current may be set to 0.2 A, but is not limited thereto. Here, the RPM of the ACP 340 and a valve opening degree value of the APC 350/ACV 360 for convergence to the minimum current may be determined and set through a pre-test (e.g., during system calibration, vehicle commissioning, or development testing, etc.) such that the current converges to the minimum current within a predetermined time, i.e., a target (e.g., minimum) current convergence target (e.g., maximum) waiting time (e.g., within 10 to 20 seconds, depending on system thermal and flow dynamics, etc.). For example, the minimum current convergence maximum waiting time may be set to a maximum of 20 seconds or less, but this is merely the embodiment, and the minimum current convergence maximum waiting time may be set differently depending on design of those skilled in the art and use and purpose of the fuel cell system (e.g., for passenger vehicles, stationary backup systems, or commercial transport applications, etc.).

If the current of the fuel cell stack 310 converges to the minimum current or less through the supply of the air at the minimum flow rate, the FCC 380 may adaptively adjust the valve opening degrees of the ACV 360 and the APC 350 through proportional-Integral-derivative (PID) control based on a voltage deviation between a target voltage and an actual stack voltage according to a preset FDC voltage drop slope (e.g., −0.9 V/s to simulate a controlled decay profile, etc.).

The FCC 380 according to the present disclosure may stably lower a current potential to a final target potential through the PID control based on the FDC voltage drop slope, and therefore, occurrence of droplets due to potential deviation and the resulting stack deterioration may be prevented in advance (e.g., mitigating cathode flooding, membrane damage, or catalyst washout, etc.). Here, a potential lowering rate may be determined by the preset FDC voltage drop slope.

Here, the PID control has the form of a feedback controller and is a method of measuring an output value of an object to be controlled, comparing the output value with a desired reference value or set point, thus calculating an error, and calculating and controlling a control value required for the control using this error value (e.g., to regulate air valve opening for voltage slope tracking, etc.).

For example, the PID control according to the present disclosure may be implemented to calculate a voltage deviation by comparing a current stack output voltage with a target stack voltage, which is a reference value (e.g., derived from a predefined voltage ramp profile, a mapped slope table, or a real-time optimization function, etc.), and to calculate and control an upward value of the opening degree of the air flow rate control valve according to the calculated voltage deviation or the calculated voltage drop slope if the voltage deviation exceeds a predetermined reference deviation (e.g., to maintain stable voltage ramp-down, suppress low-potential deviation, or improve water management, etc.).

The FDC voltage drop slope according to the embodiment may be set such that the current potential reaches the final target potential within a predetermined time (e.g., based on system warm-up duration, stack degradation level, or air supply delay, etc.). For example, ifa time allowed for the current potential to reach the final target potential after the convergence to the minimum current is 50 seconds, and a stack voltage level is 370 V after entering the idle operation state and a final target voltage level is 324 V, the FDC voltage drop slope may be calculated as −0.92V/Sec ((370V−324V)/50 Sec) (e.g., stored as a slope parameter in control logic and applied dynamically via voltage tracking algorithms, etc.).

When the stack output voltage is not gradually lowered along the FDC voltage drop slope but is quickly and forcibly lowered, a large stack current is generated in an instant and thus generates droplets in a stack (e.g., due to sudden electrochemical imbalance or water back-diffusion, etc.). In particular, in the idle operation state, there is almost no flow rate of the air supplied to the stack, and thus the generated droplets may not be blown out of the stack (e.g., due to insufficient purge flow or lack of convective removal, etc.). The droplets accumulated in the stack hinder the gas reaction (e.g., by blocking reactant access, disrupting catalyst activity, or causing local flooding, etc.). Accordingly, the stack voltage is sharply lowered, cell voltage deviation is increased, and deterioration due to low potential exposure is caused (e.g., including catalyst flooding, membrane degradation, or localized delamination, etc.).

The FCC 380 according to the embodiment may increase the valve opening degrees of the ACV 360 and the APC 350 based on a ratio of the cumulative number of times PID control is performed in the idle operation state, i.e., a cumulative PID control count, to the cumulative number of times of entries into the idle operation state after the start-up, i.e., a cumulative idle operation state entry count (e.g., using a learned correction factor or mapped offset adjustment to reflect stack aging trends or air demand variation, etc.). For example, the FCC 380 may lower a frequency of the PID control and improve followability of the stack output voltage with respect to the FDC voltage drop slope by adaptively updating and applying a target (e.g., minimum) valve opening degree value corresponding to ACV 360 and APC 350 through learning in consideration of stack degradation (e.g., caused by aging, membrane thinning, or catalyst deactivation, etc.). This may also improve valve durability performance (e.g., by reducing unnecessary actuation cycles or oscillatory control, etc.). In an embodiment, the stack degradation may be determined based on the PID control count. For example, the stack degradation may be determined based on a ratio of the cumulative number of times the PID control is performed to the number of times of entries into the idle operation state after the start-up (e.g., to quantify responsiveness loss or increased compensation demand, etc.).

When a valve opening degree for maintaining the corresponding voltage is set based on an initial stack state, as the stack is degraded, an electrochemical surface area may be reduced, and a catalyst dropout phenomenon may occur, which may not maintain a desired stack voltage due to a decrease in performance compared to the same air flow rate (e.g., requiring compensation by increased airflow or altered setpoints, etc.). To solve this problem, in the case of a normal operation state, a method of extracting a target output by increasing the current when the voltage decreases according to the stack degradation in the target output may be applied. Further, in the case of a high-power section, a large pressure deviation may occur even in a small difference in the opening degree of the APC 350. In this case, a pressure error may be compensated for by performing feedback control of the APC 350 based on an actual sensor pressure error compared to an air target pressure (e.g., using a pressure transducer signal or mapped deviation threshold, etc.).

When entering the idle operation state, the fuel cell system 300 according to the present disclosure may prevent the stack degradation due to the occurrence of the droplets in advance by performing the PID control that follows the FDC voltage drop slope and optimizing the minimum valve opening degree value in the idle operation state by learning minimum valve opening degree (e.g., updated based on PID activity frequency or voltage tracking deviation trends, etc.).

The detailed configuration and the detailed operation of the FCC 380 will be made clearer through the description of the drawings to be described later.

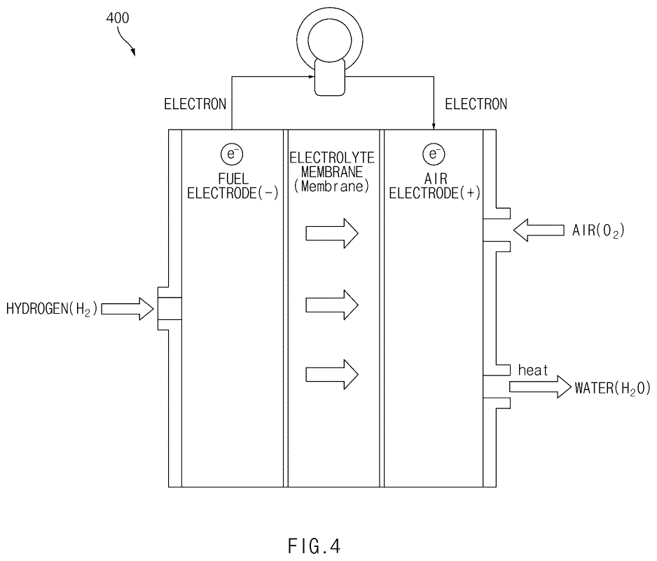

FIG. 4 shows an example of an electrochemical reaction in a fuel cell stack according to the present disclosure.

Referring to FIG. 4, a fuel cell stack 400 may roughly include a fuel electrode as a negative electrode, an air electrode as a positive electrode, and an electrolyte membrane disposed between the fuel electrode and the air electrode (e.g., a proton exchange membrane in a PEM fuel cell, etc.).

In a stack of the fuel cell system 200, hydrogen injected into the fuel electrode and oxygen injected into the air electrode react electrochemically so as to constantly generate water, i.e., generation water (H₂O) (e.g., as a byproduct of the redox reaction occurring during power generation, etc.).

Catalyst layers formed such that a chemical reaction occurs in the fuel cell stack may be included on a front side and a rear side of the electrolyte membrane. For example, the catalyst layers may be formed using carbon powder coated with a platinum (Pt)-based catalyst, but this is merely an embodiment, and other catalyst materials (e.g., iridium, ruthenium, cobalt-based materials, or platinum alloys, etc.) may be used depending on a design of those skilled in the art. The catalyst layer forms a gas diffusion layer using a catalyst (e.g., to facilitate reactant transport and water removal while maintaining electron conductivity, etc.).

The hydrogen and the oxygen injected to a left side and a right side of the stack are ionized through oxidation and reduction processes (e.g., at the anode and cathode respectively, under controlled thermal and humidification conditions, etc.).

When hydrogen (H₂) gas is injected through a hydrogen inlet formed on one side of the fuel electrode, the hydrogen reacts with the catalyst and is decomposed into hydrogen ions (H⁺) and electrons (e⁻). Here, a chemical reaction formula is 2h₂−>4H⁺+4e⁻.

The hydrogen ions pass through the electrolyte membrane and move to the air electrode, and the electrons generated from the fuel electrode pass through an external circuit and generate a current (e.g., which may be used to power drive motors or auxiliary systems, etc.). In this case, the motor of the electric vehicle may be driven using the generated current. A current generated in the fuel cell stack may be used to charge a battery provided in the electric vehicle.

When the oxygen (O₂) is injected through an air inlet formed on one side of the air electrode, the oxygen (O₂) and electrons (4e⁻) react by the catalyst to generate oxygen ions (2O²⁻), and in this case, the generated oxygen ions (2O²⁻) and hydrogen ions (4H⁻) passing through the electrolyte membrane react to generate water (2H₂O). In this case, the generated water together with heat generated during the chemical reaction in the cell is discharged to the outside through a water outlet formed on the other side of the air electrode (e.g., through an integrated water management or purge system, etc.).

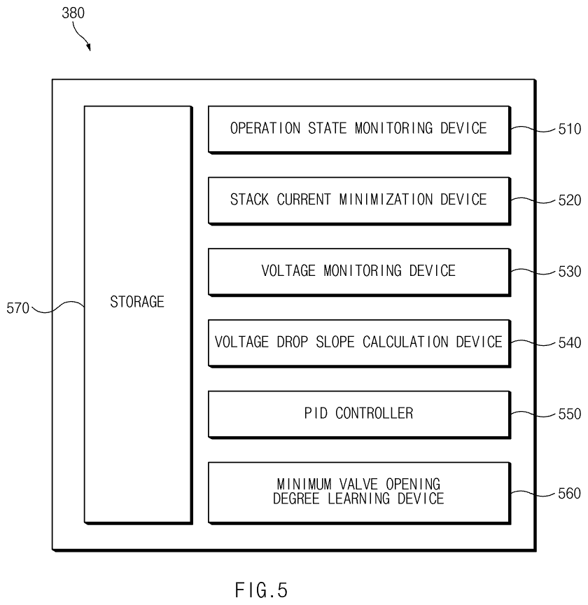

FIG. 5 shows an example of a detailed configuration of a fuel cell controller (FCC) of FIG. 3.

Referring to FIG. 5, the FCC 380 may include at least one of an operation state monitoring device 510, a stack current minimization device 520, a voltage monitoring device 530, a voltage drop slope calculation device 540 a PID controller 550, a minimum valve opening degree learning device 560, and a storage 570 (e.g., for storing calibration data, learned control parameters, or voltage profiles, etc.).

The operation state monitoring device 510 may determine whether the fuel cell stack 310 enters the idle operation state from the normal operation state based on a predefined idle operation state entry condition (e.g., such as current draw thresholds, torque demand signals, or system state transitions, etc.).

For example, the normal operation state and the idle operation state may be determined based on whether a current is withdrawn from the fuel cell stack 310 (e.g., by monitoring load demand, inverter input, or vehicle traction power request, etc.), but this is merely an embodiment, and in another embodiment, the normal operation state and the idle operation state may be determined based on at least one of the output voltage, the generated current, and an amount of supplied gas of the fuel cell stack 310 (e.g., inferred from flow sensors, pressure signals, or control flags, etc.).

When entering the idle operation state, the stack current minimization device 520 may perform a control such that the stack current converges to a preset minimum current value within a predetermined time (e.g., to prepare for voltage slope ramp-down while suppressing crossover degradation, etc.).

As an example, the stack current minimization device 520 may perform a control such that, while the ACP 340 is maintained at a minimum RPM for a predetermined period of time at an initial time point of entering the idle operation state, valve disks of the ACV 360 and the APC 350 are almost closed, e.g., controlled to 5 degrees or less (such as 1 to 3 degrees depending on system design), and thus only the minimum flow rate of the air is supplied to the cathode 111 (e.g., to suppress reaction current while avoiding oxygen starvation or cell imbalance, etc.). In this case, the current of the fuel cell stack 310 may converge to a preset minimum current or less through the supply of the air at the minimum flow rate (e.g., enabling low-load stabilization, mitigating crossover-induced degradation, or preparing for controlled voltage ramp-down, etc.). For example, the minimum current may be set to 0.2 A, but is not limited thereto. Here, the RPM of the ACP 340 and the opening degree value of the APC 350/ACV 360 for convergence to the minimum current may be determined and set through a pre-test (e.g., during factory calibration or on-board learning) such that the current converges to the minimum current within a predetermined time, i.e., the minimum current convergence maximum waiting time. For example, the minimum current convergence maximum waiting time may be set to a maximum of 20 seconds or less, but this is merely an embodiment, and the minimum current convergence maximum waiting time may be set differently depending on the design of those skilled in the art and the use and purpose of the fuel cell system (e.g., for commercial vehicles, stationary power, or auxiliary applications, etc.).

If the stack current converges to the minimum current, the voltage monitoring device 530 may monitor an output voltage of the stack (e.g., to track transient behavior and detect deviation from expected slope profiles, etc.).

The voltage drop slope calculation device 540 may calculate the FDC voltage drop slope. Here, the FDC voltage drop slope may be set such that the current potential reaches the final target potential within a predetermined time (e.g., based on stack voltage behavior during idle, degradation status, or system calibration data, etc.). For example, when the time allowed for the current potential to reach the final target potential after the convergence to the minimum current is 50 seconds (e.g., based on a pre-calibrated ramp-down profile, thermal management needs, or system protection criteria, etc.), and the stack voltage level after entering the idle operation state is 370 V and the final target voltage level is 324 V, the FDC voltage drop slope may be calculated as −0.92V/Sec ((370V−324V)/50 Sec) (e.g., stored in control memory or recalculated periodically based on operating condition updates, etc.).

The PID controller 550 may perform the PID control based on the FDC voltage drop slope to stably lower the current potential to the final target potential within a predetermined time (e.g., by modulating valve opening degrees to shape the voltage decay curve while maintaining system stability, etc.).

When it is not feasible (e.g., practically impossible) to follow the FDC voltage drop slope due to the stack degradation, the PID controller 540 may increase the opening degree of the corresponding valve (e.g., the ACV 360 or APC 350), for example, to compensate for increased internal resistance or loss of electrochemical activity, etc.

If a deviation between the target stack voltage and a current stack voltage in consideration of the FDC voltage drop slope is greater than a predetermined reference deviation, the PID controller 540 according to the embodiment may determine that it is impossible to follow the FDC voltage drop slope in a current valve opening degree state (e.g., due to insufficient airflow, membrane drying, or local flooding, etc.).

As an example, the PID controller 550 may determine an upward value of the valve opening degree based on a voltage deviation between the target stack voltage and the current stack voltage (e.g., using a proportional-integral-derivative computation based on deviation magnitude, duration, and rate of change, etc.). For example, as the voltage deviation becomes larger, the upward value of the valve opening degree may be determined as a larger value (e.g., to rapidly restore voltage tracking accuracy and prevent further deviation accumulation, etc.). Therefore, the voltage deviation may quickly recover, and thus the FDC voltage drop slope may be followed again (e.g., enabling stable voltage descent without overshoot or prolonged deviation, etc.). If the voltage deviation is greater than a reference deviation, the PID controller 550 may determine the upward value of the valve opening degree required for the stack voltage to follow the FDC voltage drop slope, and may control the air flow rate control valve based on the determined upward value of the valve opening degree (e.g., by directly commanding an actuator to increase air supply through APC 350 or ACV 360, etc.).

As another example, the PID controller 550 may calculate a stack voltage drop slope, and determine the upward value of the valve opening degree based on the calculated stack voltage drop slope (e.g., by comparing the actual rate of voltage change against a preset slope range and selecting a corresponding valve adjustment from a predefined control map, etc.). For example, stack voltage drop slope<2 V/s−>α=0.1° (valve minimum resolution), 2 V/s≤stack voltage drop slope<5 V/s−>α=1°. The upward value of the valve opening degree according to the stack voltage drop slope may be defined in the form of a mapping table and recorded and maintained in the storage device 550 (e.g., for fast lookup during real-time PID control based on dynamic stack conditions, etc.).

The PID controller 550 may identify whether the voltage deviation decreases to the reference deviation or less within a predetermined time, e.g., 1 second, after increasing the valve opening degree (e.g., as a feedback condition for confirming control effectiveness, etc.). As a result of the identification, if the voltage deviation decreases to the reference deviation or less, the PID controller 550 may terminate the PID control and maintain the current state of the valve opening degree (e.g., to prevent oscillation or valve wear, etc.).

The PID controller 550 may repeatedly perform the above-described PID control until the voltage deviation decreases to the reference deviation or less (e.g., ensuring compliance with the FDC voltage drop slope for the full duration of idle operation, etc.).

The minimum valve opening degree learning device 560 may cumulatively count the number of times of entries into the idle operation state after the start-up, and cumulatively count the number of times the PID control is performed in the idle operation state (e.g., using counters or log buffers updated by control logic, etc.).

The minimum valve opening degree learning device 560 may increase the minimum valve opening degree value based on a ratio of the cumulative PID control count to the cumulative idle operation state entry count (e.g., to reflect how frequently corrective action is needed and adapt the baseline airflow accordingly, etc.), i.e., a frequency of PID control execution (or entry) among the total idle count after the start-up. As an example, entry ratio<50%−>β=0°, 50%≤entry ratio<70%−>β=0.2°, 70%≤entry ratio−>β=0.5°. The upward value of the minimum valve opening degree according to a PID control entry ratio may be defined in the form of a mapping table and recorded and maintained in the storage 570 (e.g., to adaptively reflect stack aging trends and reduce unnecessary control effort during future idle cycles, etc.).

If the minimum valve opening degree value increases, the minimum valve opening degree learning device 560 may initialize the cumulative idle operation state entry count and the cumulative PID control count. However, the increased minimum valve opening degree value may be maintained without changing and may be used without changing when entering the idle operation state (e.g., to reduce valve actuation frequency and better accommodate aged stack conditions, etc.).

The minimum valve opening degree learning device 560 may control to increase the minimum valve opening degree by calculating a PID control ratio only if the number of times of entries into the idle operation state after the start-up is a predetermined threshold or more, for example, 10 times or more (e.g., to ensure statistically meaningful behavior before adjusting control parameters, etc.).

When the fuel cell stack 310 is restarted, the minimum valve opening degree value may be initialized (e.g., to reset learned degradation parameters and re-establish baseline air control, etc.).

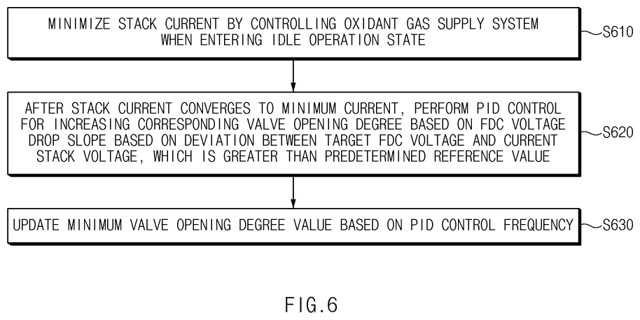

FIG. 6 shows an example of a method of controlling the opening degree of the air flow rate control valve in the fuel cell stack according to the embodiment of the present disclosure.

Referring to FIG. 6, the fuel cell system 300 may minimize the stack current by controlling the oxidant gas supply system when entering the idle operation state (S610). Here, the oxidant gas supply system may include at least one of the ACP 340, the ACV 360, and the APC 350 of FIG. 3 (e.g., coordinated to reduce airflow while preventing cathode starvation, etc.).

After the stack current converges to the minimum current, the fuel cell system 300 may perform the PID control for increasing the corresponding valve opening degree based on the FDC voltage drop slope based on a deviation between a target FDC voltage and the current stack voltage, which is greater than a predetermined reference value (S620). Here, the valve may include at least one of the ACV 360 and the APC 350 (e.g., selectively controlled based on flow balancing or pressure response, etc.).

The fuel cell system 300 may update the minimum valve opening degree value based on a frequency of the PID control compared to the cumulative idle operation state entry count after the start-up, i.e., a ratio of the PID control count to the total idle operation state entry count after the start-up (S630). Thereafter, the fuel cell system 300 may perform the PID control when entering the idle operation state using the updated minimum valve opening degree value before the restarting. When the fuel cell system 300 is restarted, the minimum valve opening degree value may be initialized (e.g., to discard outdated learning values and reset to factory calibration, etc.).

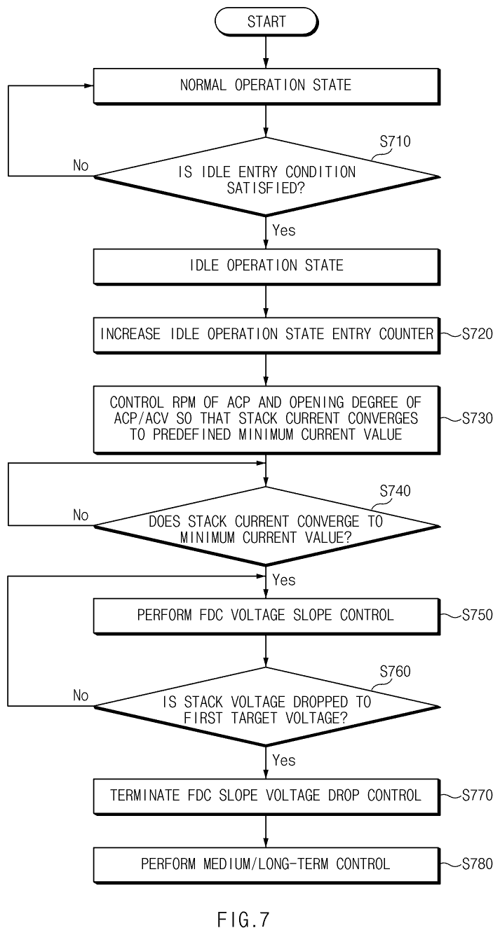

FIG. 7 shows an example of a method of controlling the opening degree of the air flow rate control valve based on the FDC voltage drop slope in the fuel cell system according to the embodiment of the present disclosure.

Referring to FIG. 7, the fuel cell system 300 may determine whether a predefined idle entry condition is satisfied in the normal operation state after the start-up (S710) (e.g., low current demand, vehicle stop, or zero load output, etc.).

As a result of the determination, if the idle entry condition is satisfied, the fuel cell system 300 may increase an idle operation state entry counter after entering the idle operation state (S720). Here, the idle operation state entry counter may be initialized when restarted (e.g., to reflect a new system cycle and discard prior learning history, etc.).

The fuel cell system 300 may adjust the RPM of the ACP 340 and the opening degree of APC 350/ACV 360 so that the stack current converges to a predefined minimum current value (S730) (e.g., below 0.2 A or another calibrated target threshold, etc.).

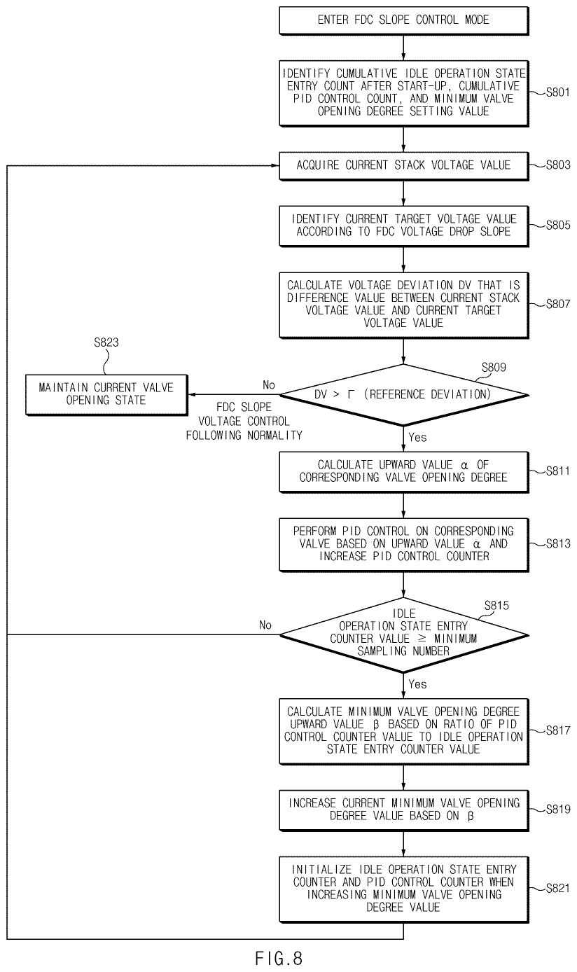

The fuel cell system 300 may enter an FDC voltage slope control mode to perform FDC voltage slope control, based on the stack current that converges to the minimum current value (S740 and S750) (e.g., enabling controlled voltage ramp-down using adaptive airflow adjustments in response to stack behavior, etc.). Here, the FDC voltage slope control may include a PID control procedure for increasing the corresponding valve opening degree and a minimum valve opening degree learning procedure for increasing the corresponding minimum valve opening degree value according to the stack degradation (e.g., adapting long-term airflow strategy to reflect aging effects, etc.). The FDC voltage slope control will become more apparent through description of FIG. 8 to be made below.

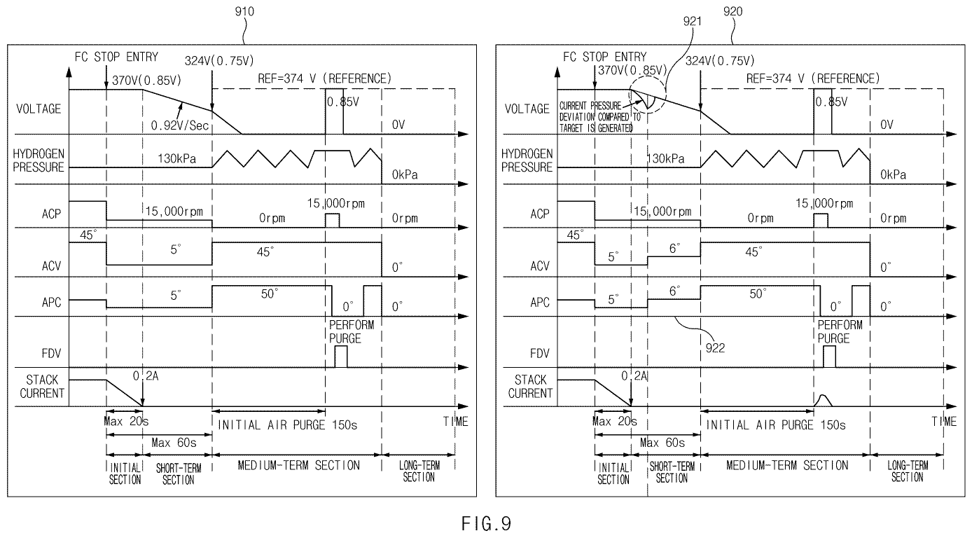

The fuel cell system 300 may terminate FDC slope voltage drop control and perform medium/long-term control based on the stack voltage, which drops to a first target voltage through the FDC voltage slope control (S760 to 780). Here, the medium/long term control will be described in detail with reference to FIG. 9 to be described below (e.g., addressing steady-state airflow, long-duration idle management, and moisture handling strategies, etc.).

FIG. 8 shows an example of a method of controlling an opening degree of an air flow rate control valve based on an FDC voltage drop slope in a fuel cell system according to another embodiment of the present disclosure.

In detail, FIG. 8 shows an example of a detailed procedure of operation S750 of FIG. 7.

Referring to FIG. 8, when entering an FDC slope control mode, the fuel cell system 300 may identify the cumulative idle operation state entry count after the start-up, the cumulative PID control count, and the minimum valve opening degree value (S801) (e.g., retrieved from stored operating history or non-volatile memory, etc.).

The fuel cell system 300 may acquire a current stack voltage value (S803) (e.g., from a high-resolution voltage monitoring circuit or sensor 370, etc.).

The fuel cell system 300 may identify a current target voltage value according to the FDC voltage drop slope (S805) (e.g., by computing the expected value at a given time point on the preconfigured slope curve, etc.).

The fuel cell system 300 may calculate a voltage deviation DV that is a difference between the current stack voltage value and the current target voltage value (S807).

The fuel cell system 300 may compare the DV with a predetermined reference deviation γ (S809) (e.g., to determine whether PID intervention is necessary, such as if DV>γ=2V, etc.).

As a result of the comparison, if the DV is greater than the γ, the fuel cell system 300 may determine that FDC slope voltage control may not be followed and may calculate the upward value α of the corresponding valve opening degree (S811). Here, the valve may include at least one of the APC 350 and the ACV 360 (e.g., selected based on their control resolution, dynamic range, or airflow sensitivity, etc.).

The fuel cell system 300 may perform the PID control on the corresponding valve based on the upward value α and increase a PID control counter (S813). Here, a current valve opening value is Aᵢ, and a valve opening value Aᵢ₊₁, which is adjusted upward through the PID control, may be calculated using an equation Aᵢ₊₁=Aᵢ+α. Here, “i” may be a natural number including 0, and A₀ is Aᵢₙᵢₜ and is a stack initial state-based evaluation setting value (e.g., a factory-set or previously learned baseline, etc.).

If the idle operation state entry counter is greater than or equal to a predefined minimum sampling number, the fuel cell system 300 may calculate a minimum valve opening degree upward value β based on a ratio of a PID control counter value to an idle operation state entry counter value (S815 to S817) (e.g., to update the learned minimum valve opening degree used in subsequent idle sessions, etc.).

If the idle operation state entry counter is less than the predefined minimum sampling number, the fuel cell system 300 may enter operation S803 again (e.g., to continue collecting runtime data until sufficient samples are available for learning, etc.).

The fuel cell system 300 may increase the current minimum valve opening degree value based on the calculated minimum valve opening degree upward value β (S819). Here, when the current minimum valve opening degree value is Bᵢ and the updated minimum valve opening degree value is Bᵢ₊₁, an equation Bᵢ₊₁=Bᵢ+β may be calculated. Here, “i” is a natural number including 0, B₀ is Bᵢₙᵢₜ and is 0 (e.g., representing the baseline valve opening degree at the time of system commissioning, etc.).

The fuel cell system 300 may initialize the idle operation state entry counter and the PID control counter if the minimum valve opening degree value is increased (S821) (e.g., to start a new learning cycle with the updated baseline, etc.).

In operation S809, when the DV is less than or equal to γ, the fuel cell system 300 may determine that the FDC slope voltage control is normally followed, and thus maintain the current valve opening degree state (S823) (e.g., avoiding unnecessary control adjustments or valve wear, etc.).

In the embodiment, the minimum valve opening degree value may be maintained without changing when re-entering the idle operation state and may be initialized only if restart-up is performed. For example, during the restart-up, a loop of operation S803 to operation S821 may be performed based on the Aᵢₙᵢₜ and the Bᵢₙᵢₜ (e.g., to ensure repeatable initial behavior after vehicle power-off, etc.).

FIG. 9 shows an example of an example of controlling the opening degree of the air flow rate control valve based on the FDC voltage drop slope in the fuel cell system according to the embodiment of the present disclosure.

Reference numeral 910 illustrates valve opening degree control if there is no voltage deviation that is greater than or equal to a reference value due to the stack degradation when the FDC slope-based voltage is dropped after entering the idle operation state (e.g., indicating that the system is able to follow the target voltage profile without requiring PID correction, suggesting minimal degradation effects, etc.). Reference numeral 920 illustrates valve opening degree control when the PID control that increases the corresponding valve opening degree value is performed if there is no voltage deviation that is greater than or equal to a reference value due to the stack degradation when the FDC slope-based voltage is dropped after entering the idle operation state (e.g., reflecting corrective air control to follow the predefined slope under aging conditions, etc.).

A control section in the idle operation state may be roughly divided into an initial section, a short-term section, a medium-term section, and a long-term section (e.g., based on time since idle entry or system voltage/current behavior, etc.).

Referring to reference numeral 910, after the fuel cell stack enters a stopped state (i.e., the idle operation state), the fuel cell system 300 may control the air flow rate so that the stack current converges to 0.2 A, which is a minimum current, within an initial control period of up to 20 seconds (e.g., to stabilize the electrochemical reaction at minimal load and prepare for controlled voltage ramp-down, etc.). In this case, the ACP 340 may be decreased to 15,000 RPM that is a minimum value, and the opening degree values of the APC 350 and the ACV 360 may be decreased from the existing 45 degrees to 5 degrees (e.g., to reduce or minimize oxidant flow while maintaining sufficient airflow to prevent cathode starvation or pressure imbalance, etc.). If the stack current converges to the minimum current according to initial section control, the stack voltage may be dropped from the initial 370 V and reach 324 V at a speed of 0.92 V/sec according to the FDC voltage drop slope within a short-term control section of up to 60 seconds (e.g., ensuring controlled voltage descent to avoid rapid potential shifts that could cause membrane stress or water accumulation, etc.). Here, a hydrogen pressure may be constantly maintained at 130 kPa in the initial control section and the short-term control section (e.g., to ensure stable hydrogen supply without excess purge, etc.).

The hydrogen pressure may be increased to 150 kPa for 150 seconds from the medium-term control section to an initial air purge, driving of the ACP 340 may be stopped, and the valve opening degree values of the APC 350 and the ACV 360 may be increased to 50 degrees and 45 degrees, respectively (e.g., to promote effective gas exchange, remove residual water, and prevent localized flooding in the stack, etc.). During the purge by the FDV 170, the valve of the APC 350 may be closed, and the ACP 340 may be temporarily driven at a minimum RPM. When entering the long-term control section after the purge is completed, all flow rate control valves are closed, and driving of the ACP 340 is stopped (e.g., to maintain stack in a sealed low-flow idle state for storage or soak conditions, etc.).

As indicated by reference numeral 921 of reference numeral 920, if the stack voltage fails to follow the FDC slope and a voltage deviation from the target voltage is greater than or equal to a reference value, as indicated by reference numeral 922, the fuel cell system 300 may control such that the stack voltage follows the FDC slope again by increasing (e.g., to enhance air supply, promote proper reactant distribution, and reduce potential deviation caused by insufficient oxidant availability, etc.) the opening degrees of the ACV 360 and the APC 350, which are air flow rate control valves, to six degrees (e.g., providing a small but sufficient increase in airflow to restore voltage tracking without overshooting, etc.). For example, the fuel cell system 300 may control to estimate the FDC voltage drop slope by performing the PID control on the air flow rate control valve according to the stack degradation (e.g., dynamically adjusting the slope based on historical voltage response and corrective airflow behavior, etc.).

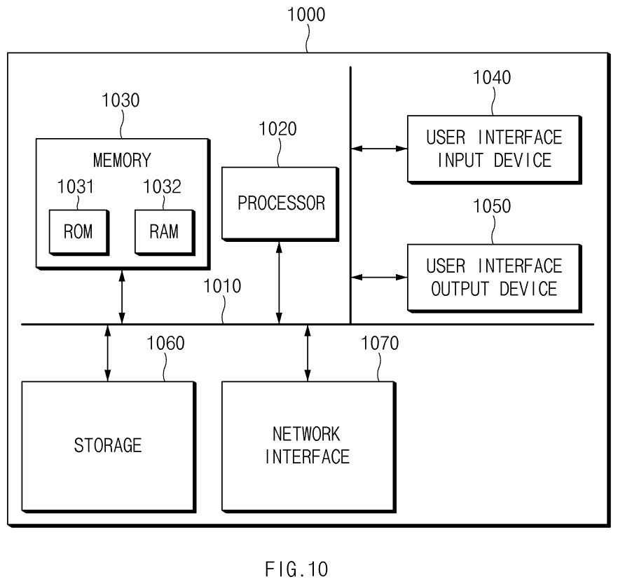

FIG. 10 shows an example of a computing device according to the embodiment of the present disclosure.

Referring to FIG. 10, a computing device 1000 may include at least one of at least one processor 1020, a memory 1030, a user interface input device 1040, a user interface output device 1050, storage 1060, and a network interface 1070 that are connected through a bus 1010 (e.g., to support data flow among system components and external interfaces, etc.).

The processor 1020 may be a central processing unit (CPU) or a semiconductor device that processes commands stored in the memory 1030 and/or the storage 1060. The memory 1030 and the storage 1060 may include various types of volatile or nonvolatile storage media. For example, the memory 1030 may include a read only memory (ROM) 1031 and a random access memory (RAM) 1032 (e.g., for storing executable firmware and runtime data buffers, respectively, etc.).

Thus, the operations of the method (or procedure) or the algorithm described in connection with the embodiments disclosed herein may be directly implemented by a hardware module, a software module, or a combination of both the hardware module and the software module, which is executed by the processor 1020. The software module may reside in a storage medium (e.g., the memory 1030 and/or the storage 1060) such as a RAM, a flash memory, a ROM, an EPROM, an EEPROM, a register, a hard disk, a removable disk, and a compact disk (CD)-ROM. For example, the processor 1020 may constitute a part of the fuel cell vehicle system described above and may correspond to the controller (ECU) 70 of FIG. 2 and/or the fuel cell controller 380 of FIG. 3 (e.g., executing control logic for valve regulation, stack protection, and slope tracking in real-time, etc.).

The exemplary storage medium may be coupled to the processor 1020, and the processor 1020 may read information from the storage medium and write the information to the storage medium. In another manner, the storage medium may be formed integrally with the processor 1020. The processor and the storage medium may reside inside an application-specific integrated circuit (ASIC). The ASIC may also reside in an in-vehicle controller (e.g., for real-time execution of fuel cell control logic, stack monitoring, and air flow regulation, etc.). In another manner, the processor 1020 and the storage medium may also reside as individual components within the vehicle controller or the vehicle fuel cell system (e.g., as part of a distributed embedded architecture, where memory and processing functions are handled by separate modules communicating over a CAN or Ethernet network, etc.).

An aspect of the present disclosure provides a method of controlling an opening degree of an air flow rate control valve in a fuel cell stack and an apparatus therefor.

Another aspect of the present disclosure provides a method for adaptively controlling an opening degree of an air flow rate control valve according to stack degradation in a fuel cell system that has entered an idle operation state, and an apparatus therefor.

Still another aspect of the present disclosure provides a method of controlling an opening degree of an air flow rate control valve in a fuel cell stack, which may prevent stack degradation in advance by minimizing occurrence of droplets in a stack by performing proportional-integral-derivative (PID) control for an air flow rate control valve based on a fuel-cell DC-DC converter (hereinafter, referred to as an “FDC”) voltage drop slope after minimizing a stack current in an idle operation state, and an apparatus therefor.

Yet another aspect of the present disclosure provides a method of controlling an opening degree of an air flow rate control valve in a fuel cell stack therefor, which may improve FDC voltage drop slope followability by adaptively increasing a minimum valve opening degree value of an oxidant gas supply system valve and may improve valve durability by lowering a PID control frequency according to a ratio of PID control to an idle operation state entry count after start-up, and an apparatus therefor.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a method of controlling an opening degree of an air flow rate control valve in a fuel cell system includes performing a control such that a current of a stack converges to a predetermined minimum current based on entry into an idle operation state after start-up and controlling a fuel-cell direct current DC-DC converter (FDC) voltage drop slope based on the current of the stack converging to the minimum current.

As an embodiment, the method may further include performing a proportional-integral-derivative (PID) control for the air flow rate control valve by monitoring a voltage of the stack, and increasing a minimum valve opening degree value of the air flow rate control valve based on a degradation degree of the stack, wherein the degradation degree may be determined based on a PID control entry count.

As an embodiment, the air flow rate control valve may include an air cut-off valve (ACV) that is a valve that blocks air supplied to the stack and an air pressure control valve (APC) that is a valve that controls an air pressure.

As an embodiment, the performing of the PID control may include acquiring a current output voltage value of the stack, acquiring a target stack voltage value corresponding to the current output voltage value, and calculating a voltage deviation between the target stack voltage value and the current output voltage value, wherein the PID control may be performed based on the voltage deviation that is greater than a predetermined reference deviation.

As an embodiment, the target stack voltage value corresponding to the current output voltage value may be determined based on the FDC voltage drop slope corresponding to the idle operation state.

As an embodiment, the FDC voltage drop slope may be determined by (b−a)/t based on an output voltage a of the stack after entering the idle operation state, a final target voltage b according to the FDC voltage drop slope, and a maximum waiting time t for reaching the final target voltage.

As an embodiment, the performing of the PID control may further include determining a valve opening degree upward value required for the voltage of the stack to follow the FDC voltage drop slope if the voltage deviation is greater than the reference deviation, and controlling the air flow rate control valve based on the determined valve opening degree upward value.

As an embodiment, the increasing of the minimum valve opening degree value may include counting an idle operation state entry count after the start-up, counting a PID control count in the idle operation state, calculating a ratio of the PID control count to the idle operation state entry count after the start-up, and determining a minimum valve opening degree upward value based on the ratio.

As an embodiment, the ratio may be calculated based on the idle operation state entry count after the start-up, which is greater than a predetermined reference value.

As an embodiment, if the voltage deviation is smaller than or equal to the predetermined reference deviation, it may be determined that the FDC voltage drop slope is normally followed, and thus an opening degree state of the air flow rate control valve may be maintained.

As an embodiment, the minimum valve opening degree value may be initialized upon re-start.

According to another aspect of the present disclosure, a computing device provided in a fuel cell system includes a processor that executes commands and a memory that stores the commands, wherein the commands are implemented to perform a control such that a current of a stack converges to a predetermined minimum current based on entry into an idle operation state after start-up and to control a fuel-cell direct current DC-DC converter (FDC) voltage drop slope based on the current of the stack converging to the minimum current.

As an embodiment, the processor may perform a proportional-integral-derivative (PID) control for an air flow rate control valve by monitoring a voltage of the stack and increase a minimum valve opening degree value of the air flow rate control valve based on a degradation degree of the stack, and the degradation degree may be determined based on a PID control entry count.

As an embodiment, the air flow rate control valve may include an air cut-off valve (ACV) that is a valve that blocks air supplied to the stack and an air pressure control valve (APC) that is a valve that controls an air pressure.

As an embodiment, the processor may acquire a current output voltage value of the stack, identify a target stack voltage value corresponding to the current output voltage value, and calculate a voltage deviation between the target stack voltage value and the current output voltage value, and the PID control may be performed based on the voltage deviation that is greater than a predetermined reference deviation.

As an embodiment, the target stack voltage value corresponding to the current output voltage value may be determined based on the FDC voltage drop slope corresponding to the idle operation state.

As an embodiment, the FDC voltage drop slope may be determined by (b−a)/t based on an output voltage a of the stack after entering the idle operation state, a final target voltage b according to the FDC voltage drop slope, and a maximum waiting time t for reaching the final target voltage.

As an embodiment, the processor may determine a valve opening degree upward value required for the voltage of the stack to follow the FDC voltage drop slope if the voltage deviation is greater than the reference deviation and control the air flow rate control valve based on the determined valve opening degree upward value.

As an embodiment, the processor may count an idle operation state entry count after the start-up, count a PID control count in the idle operation state, calculate a ratio of the PID control count to the idle operation state entry count after the start-up, and determine a minimum valve opening degree upward value based on the ratio.

As an embodiment, the processor may calculate the ratio based on the idle operation state entry count after the start-up, which is greater than a predetermined reference value.

As an embodiment, if the voltage deviation is smaller than or equal to the predetermined reference deviation, the processor may determine that the FDC voltage drop slope is normally followed and perform a control to maintain an opening degree state of the air flow rate control valve.

As an embodiment, the minimum valve opening degree value may be initialized upon re-start.

The present technology provides a method of controlling an opening degree of an air flow rate control valve in a fuel cell stack, and an apparatus therefor.

Further, the present technology may prevent stack degradation by adaptively controlling an opening degree of an air flow rate control valve according to the stack degradation in a fuel cell system entering an idle operation state.

Further, the present technology may prevent stack degradation by minimizing occurrence of droplets in a stack by performing PID control for an air flow rate control valve based on a FDC voltage drop slope after a stack current is minimized in an idle operation state.

Further, the present technology may improve durability of a valve by improving FDC voltage drop slope followability and lowering a PID control frequency by adaptively increasing a minimum valve opening degree value of an oxidant gas supply system valve according to a ratio of a PID control count to an idle operation state entry count after start-up.

In addition, various effects directly or indirectly identified though the present document may be provided.

The above description is merely illustrative of the technical spirit of the present disclosure, and those skilled in the art to which the present disclosure belongs may make various modifications and changes without departing from the essential features of the present disclosure.

Thus, the embodiments disclosed in the present disclosure are not intended to limit the technology spirit of the present disclosure, but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

What is claimed:

1. A method performed by an apparatus of a fuel cell system, the method comprising:
based on entry into an idle operation state of a fuel cell stack of the fuel cell system after start-up of the fuel cell system, controlling airflow to the fuel cell stack such that a current of the fuel cell stack converges to a predetermined current;
based on the current of the fuel cell stack converging to the predetermined current, controlling a voltage drop slope of a fuel-cell direct current DC-DC converter (FDC); and
controlling, based on the controlled voltage drop slope of the FDC, an operation of the fuel cell stack.

2. The method of claim 1, further comprising:
performing, based on a voltage of the fuel cell stack, a feedback-based control for an air flow rate control valve of the fuel cell system; and
increasing, based on a degradation degree value of the fuel cell stack, a valve opening degree value of the air flow rate control valve,
wherein the degradation degree value of the fuel cell stack is determined based on a count of instances of performing the feedback-based control during the idle operation state of the fuel cell stack.

3. The method of claim 2, wherein the air flow rate control valve comprises:
an air cut-off valve (ACV) that is a valve configured to block air supplied to the fuel cell stack, and
an air pressure control valve (APC) that is a valve configured to control an air pressure.

4. The method of claim 2, wherein the performing of the feedback-based control comprises:
obtaining a current output voltage value of the fuel cell stack;
obtaining a target output voltage value of the fuel cell stack associated with the current output voltage value; and
identifying a voltage deviation between the target output voltage value and the current output voltage value, and
wherein the feedback-based control is performed based on the voltage deviation being greater than a predetermined reference deviation.

5. The method of claim 4, wherein the target output voltage value is determined based on the voltage drop slope of the FDC, and wherein the voltage drop slope of the FDC is applied during the idle operation state of the fuel cell stack.

6. The method of claim 5, wherein the voltage drop slope of the FDC is determined based on:
an output voltage value of the fuel cell stack after entering the idle operation state,
the target output voltage value, and
a predetermined waiting time for reaching the target output voltage value.

7. The method of claim 5, wherein the performing of the feedback-based control further comprises:
based on the voltage deviation being greater than the predetermined reference deviation, determining a valve opening degree upward value required for the current output voltage value of the fuel cell stack to follow the voltage drop slope of the FDC; and
controlling, based on the determined valve opening degree upward value, the air flow rate control valve.

8. The method of claim 2, wherein the increasing of the valve opening degree value comprises:
counting a number of instances of entering into the idle operation state of the fuel cell stack after the start-up of the fuel cell system;
counting a number of instances of performing the feedback-based control during the idle operation state of the fuel cell stack;
calculating a ratio of the number of instances of performing the feedback-based control to the number of instances of entering into the idle operation state; and
determining, based on the ratio, a valve opening degree upward value, and
wherein the ratio is calculated based on the number of instances of entering into the idle operation state after the start-up being greater than a predetermined reference value.

9. The method of claim 4, further comprising:
based on the voltage deviation being less than or equal to the predetermined reference deviation, determining that an output voltage value of the fuel cell stack is within a voltage value range defined by the voltage drop slope of the FDC; and
controlling the air flow rate control valve to maintain a current opening degree.

10. The method of claim 2, further comprising:
initializing, upon re-start of the fuel cell system, the valve opening degree value of the air flow rate control valve.

11. An apparatus of a fuel cell system, the apparatus comprising:
a processor; and
a memory storing at least one instruction that, when executed by the processor communicating with the memory, is configured to cause the apparatus to:
based on entry into an idle operation state of a fuel cell stack of the fuel cell system after start-up of the fuel cell system, control airflow to the fuel cell stack such that a current of a fuel cell stack converges to a predetermined current, and
based on the current of the fuel cell stack converging to the predetermined current, control a voltage drop slope of a fuel-cell direct current DC-DC converter (FDC).

12. The apparatus of claim 11, wherein the at least one instruction, when executed by the processor communicating with the memory, is configured to cause the apparatus to:
perform, based on a voltage of the fuel cell stack, a feedback-based control for an air flow rate control valve of the fuel cell system, and
increase, based on a degradation degree value of the fuel cell stack, a valve opening degree value of the air flow rate control valve, and
wherein the degradation degree value of the fuel cell stack is determined based on a count of instances of performing the feedback-based control during the idle operation state of the fuel cell stack.

13. The apparatus of claim 12, wherein the air flow rate control valve comprises:
an air cut-off valve (ACV) that is a valve configured to block air supplied to the fuel cell stack, and
an air pressure control valve (APC) that is a valve configured to control an air pressure.

14. The apparatus of claim 12, wherein the at least one instruction, when executed by the processor communicating with the memory, is configured to cause the apparatus to perform the feedback-based control by:
obtaining a current output voltage value of the fuel cell stack,
identifying a target output voltage value of the fuel cell stack associated with the current output voltage value, and
identifying a voltage deviation between the target output voltage value and the current output voltage value, and
wherein the feedback-based control is performed based on the voltage deviation being greater than a predetermined reference deviation.

15. The apparatus of claim 14, wherein the target output voltage value is determined based on the voltage drop slope of the FDC, and wherein the voltage drop slope of the FDC is applied during the idle operation state of the fuel cell stack.

16. The apparatus of claim 15, wherein the voltage drop slope of the FDC is determined based on:
an output voltage value of the fuel cell stack after entering the idle operation state,
the target output voltage value, and
a predetermined waiting time for reaching the target output voltage value.

17. A method performed by an apparatus of a fuel cell system, the method comprising:
reducing, based on detecting entry into an idle operation state of a fuel cell stack of the fuel cell system, an air supply to the fuel cell stack to decrease a current of the fuel cell stack;
controlling, based on the current of the fuel cell stack being reduced to a predetermined threshold, a voltage of the fuel cell stack to follow a predefined voltage drop profile during the idle operation state;
adjusting an air supply condition based on a deviation between the voltage of the fuel cell stack and a reference voltage; and
controlling, based on the adjusted air supply condition, an operation of the fuel cell system.

18. The method of claim 17, wherein the adjusting of the air supply condition comprises adjusting, based on the deviation, an opening degree of an air flow control valve of the fuel cell system.

19. The method of claim 17, further comprising:
based on a frequency of adjustments during a plurality of idle operation states of the fuel cell stack, updating a control parameter for the air supply condition.

20. The method of claim 17, wherein the predefined voltage drop profile is defined based on a difference between an initial voltage of the fuel cell stack and a target output voltage value and based on a time duration for reaching the target output voltage value.
